(19) United States
(12) Patent Application Publication
(10) Pub. No.: US 2010/0281407 A1
(43) Pub. Date: Nov. 4, 2010

(54) INFORMATION PROVIDING DEVICE, INFORMATION DISPLAY DEVICE, INFORMATION PROVIDING SYSTEM, INFORMATION PROVIDING METHOD, PROGRAM, AND COMPUTER-READABLE STORAGE MEDIUM HAVING PROGRAM STORED THEREIN

(76) Inventors: Kazuyuki Yokogawa, Osaka (JP); Takanobu Matsubara, Osaka (JP); Kiyotaka Kashito, Osaka (JP)

Correspondence Address: BIRCH STEWART KOLASCH & BIRCH, PO BOX 747, FALLS CHURCH, VA, 22040-0747, US

(21) Appl. No.: 12/810,498

(22) PCT Filed: Dec. 22, 2008
(86) PCT No.: PCT/JP2008/073906

§ 371 Date: Jun. 24, 2010

Related U.S. Application Data
(60) Provisional application No. 61/009,221, filed on Dec. 27, 2007.

(30) Foreign Application Priority Data
May 16, 2008 (JP) 2008-130034

(51) Int. Cl. G06F 3/048

(52) U.S. Cl. 715/764

(57) ABSTRACT

A sidebar providing server (2) according to the present invention includes a request message analysis section (70), a control script generation section (80), and a display data generation section (63). The request message analysis section (70) receives service setting data transmitted from a digital television (1). The control script generation section (80) generates a control script for causing the digital television (1) to display an object indicating a brief description of the service, that is associated with setting information utilized to acquire information related to the service, which setting information is included in the service setting data thus received. The display data generation section (63) generates display data which includes the object and the control script thus generated, and transmits the display data thus generated to the digital television (1).

### TECHNICAL FIELD

The present invention relates to an information providing device, an information display device, an information providing system, an information providing method, a program, and a computer-readable storage medium having such program stored therein, each of which is for providing information to a user of the information display device via a communication network.

### BACKGROUND ART

In recent years, not only general-purpose devices such as personal computers but also application-specific devices such as televisions, mobile phones and game machines include, as a standard fixture, a communication function for communicating with external devices via an external communication network such as the Internet. Each of these devices is capable of receiving various services from service distributing servers that provide various services, via the Internet.

Patent Document 1 discloses a technique that allows displaying, on an image display device that serves as a client, a photograph stored in a server device that is located in a remote area, by use of a network such as the Internet. The image display device requests a photograph from the server device via the network, in response to an operation of a user, and displays the photograph that is acquired, in response to the request, from the server device.
[Patent Document 1]
Japanese Patent Application No. 168098/2007 (Tokugan 2007-168098; filed on Jun. 26, 2007)

### DISCLOSURE OF INVENTION

### Problem to be Solved by the Invention

In the technique disclosed in Patent Document 1, when such request is to be made to the server device, the image display device which serves as the client generates a message for making such request to the server device. This message is generated based on information included in a log table of an album containing the photograph, which log table is stored in the image display device. Meanwhile, a predetermined amount of time is required until the request is made, since processing steps of (i) reading out necessary information from the log table, and (ii) incorporating the information thus read out to the message in a predetermined data format, are necessarily carried out. As a result, the following problem occurs: after the operation of the user is made, a predetermined lag occurs until the photograph is acquired from the server device.

Moreover, in a system in which the server device customizes a processing carried out in accordance with a request from the client device, a system arrangement that causes a client device to transmit information subject to customization to the server device causes a problem such that a modification may be required to the functions provided in the client device when a customization content is to be modified.

The present invention is attained in view of the problems, and its object is to provide an information providing device, an information display device, an information providing system, an information providing method, a program, and a computer-readable storage medium storing such program, each of which can (i) provide data that is customized in accordance with a client device, and (ii) flexibly modify content of customization by a server device.

### Means to Solve the Problems

In order to solve the problems, an information providing device according to the present invention is an information providing device which provides display data for presentation of a user interface on an information display device, the information display device acquiring information related to one or more services from a service providing device via the user interface and displaying the information thus acquired, the information providing device, including: a service setting data receiving section for receiving, from the information display device, service setting data which includes (i) setting information for causing the information display device to acquire the information related to the one or more services and (ii) identification information of the one or more services; a control script generation section for generating a control script which causes the information display device to display an object indicating a brief description of the one or more services, the object being associated with the setting information included in the service setting data thus received; and a display data transmission section for generating display data which includes the object and the control script thus generated, and transmitting the display data thus generated to the information display device.

Moreover, an information providing method according to the present invention is a method for controlling an information providing device which provides display data for presentation of a user interface on an information display device, the information display device acquiring information related to one or more services from a service providing device via the user interface and displaying the information thus acquired, the method including the steps of: receiving, from the information display device, service setting data which includes (i) setting information for causing the information display device to acquire the information related to the one or more services and (ii) identification information of the one or more services; generating a control script which causes the information display device to display an object indicating a brief description of the one or more services, the object being associated with the setting information included in the service setting data thus received; generating display data which includes the object and the control script thus generated; and transmitting the display data thus generated to the information display device.

According to the arrangement, the service setting data is receivable from the information display device. It is also possible to generate the control script for causing display of the object associated with the setting information included in the service setting data thus received. Moreover, it is possible to generate the display data which includes the object and the control script thus generated, and transmit the display data thus generated to the information display device.

This allows (i) generation of the display data that includes the object corresponding to the setting information included in the service setting data received from the information display device, and (ii) transmission of such display data to the information display device.

As a result, an effect is attained such that control for including, in the display data, the object that corresponds to the setting information can be carried out just by the information providing server, that is, the server device. Namely, an effect is attained such that the control for displaying the object on the information display device can be carried out just by the information providing device.

An information providing system according to the present invention includes: the information providing device; and the information display device.

According to the present invention, the information display device collectively reads out the service setting data stored in the second storage section and transmits this service setting data as it is to the information providing device. Subsequently, the information providing device receives the service setting data from the information display device. The information providing device generates the control script for causing the information display device to display the object that corresponds to the setting information included in the service setting data thus received. The information providing device further generates the display data including the object and the control script thus generated, and transmits a generated display data to the information display device. Accordingly, the information display device displays the object on its display section in accordance with the control script included in the display data acquired from the information providing device.

This allows the information providing device to transmit display data generated based on the service setting data collectively read out from the second storage section by the information display device, and the information display device to display the object on its device based on the display data.

As a result, control for displaying the object on the information display device can be carried out just by the information providing device which is the server device, even if the information display device does not perceive what data format the service setting data is in, or what kind of data is stored in the service setting data.

The information providing device and the information display device may be realized by a computer. In this case, a control program of the information providing device and the information display device which causes the computer to function as each of the sections of the information providing device and the information display device, and a computer-readable storage medium in which such program is stored, are also within the scope of the present invention.

### BRIEF DESCRIPTION OF DRAWINGS

FIG. 1 is a drawing showing a schematic configuration of a service providing system of an embodiment of the present invention.

FIG. 2 is a drawing showing an example of a schematic configuration of a digital television in the service providing system explained in FIG. 1.

FIG. 3 is a drawing schematically showing a data structure of a display data request message generated by the digital television explained in FIG. 2.

FIG. 4 is a block diagram showing a schematic configuration of a sidebar providing server in the service providing system explained in FIG. 1.

FIG. 5 is a drawing schematically showing a data structure of display data generated by the sidebar providing server explained in FIG. 4.

FIG. 6 is a schematic drawing showing a data format of service setting data handled by the service providing system explained in FIG. 1.

FIG. 7 is a schematic drawing showing an example of the service setting data explained in FIG. 6.

FIG. 8 is a flow chart showing an example of a series of processing steps in which a sidebar providing server in the service providing system explained in FIG. 1 (i) generates display data that is customized in accordance with service setting data and (ii) transmits this generated display data to the digital television in the service providing system explained in FIG. 1.

FIG. 9 is a drawing showing an example of a screen on which a sidebar is displayed, in the digital television explained in FIG. 2.

FIG. 10 is a drawing showing an example of a screen on which a service downloaded from a service distributing server 3 is displayed, in the digital television explained in FIG. 2.

FIG. 11 is a drawing showing another example of a screen on which a sidebar is displayed, in the digital television explained in FIG. 2.

FIG. 12 is a drawing showing another example of a screen on which a sidebar is displayed, in the digital television explained in FIG. 2.

### REFERENCE NUMERALS

1 digital television (information display device)
2 sidebar providing server (information providing device)
3 service distributing server (service providing device)
5 display data request message
6 image (object)
7 display data
7′ sidebar (user interface)
8 service
10 control section
14 image superimposing section
16 display section
17 storage section (first storage section)
20 temporary storage section
21 interface section
30 event processing section
32 display data request processing section (display data request means)
33 display data execution processing section (display data display means)
34 browser processing section
60 control section
62 pattern data selecting section
63 display data generation section (display data transmission means)
64 service image acquisition section (object acquisition means)
70 request message analysis section (service setting data receiving means)
80 control script generation section (control script generation means)
90 storage section (second storage section)
91 pattern data storage section
92 service image storage section
93 common object storage section
100 service providing system (information providing system)

### BEST MODE FOR CARRYING OUT THE INVENTION

One embodiment of the present invention is described below with reference to the attached drawings. The present embodiment discusses an example in which an information display device of the present invention is a digital television. Further, an information providing device of the present invention is explained as a sidebar providing server for providing a sidebar function to digital televisions. The sidebar function is a tool for (i) displaying brief description information of services that are available on the digital television and (ii) activating such services. The sidebar function is described later in detail.

When a service is activated via a sidebar displayed on a digital television, contents of the service is provided to the digital television from a service distributing server of a service provider.

In the following explanation, an information providing system of the present invention is applied to a service providing system including the digital television, the sidebar providing server and the service distributing server.

However, the information display device, the information providing device and the information providing system of the present invention are not limited to the following concrete examples.

(Outline of Service Providing System)

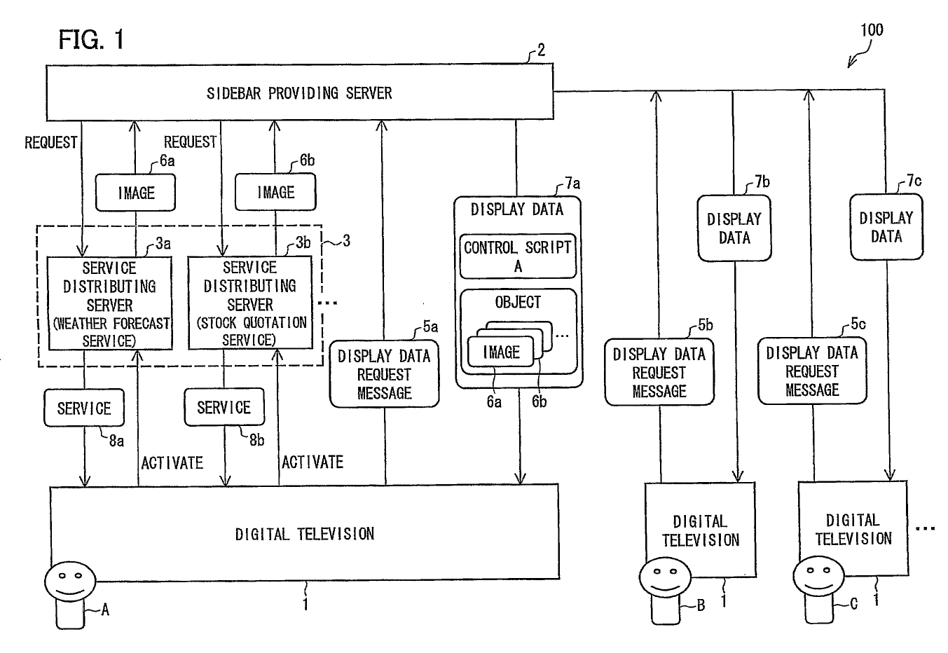

FIG. 1 is a drawing showing a schematic configuration of a service providing system 100 of the embodiment of the present invention. As shown in FIG. 1, the service providing system 100 includes a digital television 1, a sidebar providing server 2 and a service distributing server 3.

The digital television 1 carries out a sidebar function provided from the sidebar providing server 2 and uses services provided by the service distributing server 3.

The sidebar function is a function of a digital television, and the function includes a sidebar displaying function and a service launcher function. The sidebar displaying function is a function of displaying, on a corner of a screen of the digital television, brief descriptions of services which are available in the digital television, like a toolbar (OSD (On-Screen-Display)). The service launcher function is a function of activating a service displayed on the sidebar when the service is selected.

One or more than one digital television 1 requests the sidebar providing server 2 to provide display data 7 (7a, 7b, 7c . . . ) necessary for displaying, on the digital television 1, a sidebar having the above function. Specifically, the digital television 1 transmits a display data request message 5 (5a, 5b, 5c . . . ) to the sidebar providing server 2. The display data 7 and the display data request message 5 are later described in detail.

The sidebar providing server 2 provides the display data 7 generated specially for the digital television 1 independently, to the digital television 1 in response to the display data request message 5 transmitted from the digital television 1. The sidebar providing server 2 tailor-makes the display data 7 specially for each digital television 1 independently.

First, the sidebar providing server 2 requests the service distributing server 3 (3a, 3b . . . ), that distributes services, to provide an image 6 (6a, 6b . . . ) showing a brief description of a service to be contained in the sidebar. The sidebar providing server 2 requests the image from one or more than one service distributing server 3. How many and which service distributing server 3 the sidebar providing server 2 requests the image from differs according to the digital television 1 requesting the sidebar. That is, the sidebar providing server 2 customizes the display data 7 (contents of the sidebar) according to the digital television 1 requesting the sidebar.

The service distributing server 3 may provide the image 6 in response to the request of the sidebar providing server 2. As an alternative, when information is updated in the service distributing server 3, the service distributing server 3 may provide, to the sidebar providing server 2, the image 6 containing the updated information.

Further, in the example shown in FIG. 1, the service distributing server 3 provides, to the sidebar providing server 2, the information containing a brief description of a service by using image-form data such as the image 6. However, a form of the data is not limited to this. For example, the service distributing server 3 may provide, in response to the request of the sidebar providing server 2, text-form data or complex data containing image data and text data, as brief description information of a service.

The sidebar providing server 2 generates the display data 7 containing collected objects such as the image 6 and a control script for determining how the objects are displayed, and then transmits the display data 7 to the digital television 1. The digital television 1 can display a sidebar customized for the digital television 1 by analyzing and executing the display data 7. Brief description information of various services which can be used in the digital television 1 is displayed on the sidebar, and when a service is selected by a user (A, B, C . . . ), that service selected is activated.

The service distributing server 3 returns, in response to the request of the sidebar providing server 2, the image 6 showing a brief description of a service, and at the same time, provides a service 8 (8a, 8b . . . ) in response to the request of the digital television 1 via the sidebar. For example, when the service distributing server 3 provides a weather forecast service, the service distributing server 3 provides the service 8a containing weather forecast information. The service distributing server 3 may be plural. Further, the service 8 may be provided to a plurality of digital televisions 1.

As described above, according to the service providing system 100, the digital television 1 can acquire, from the sidebar providing server 2, the sidebar function customized for the digital television 1 and can display the sidebar on the digital television 1. A user of the digital television 1 can easily activate desired services by using the customized sidebar.

(Digital Television)

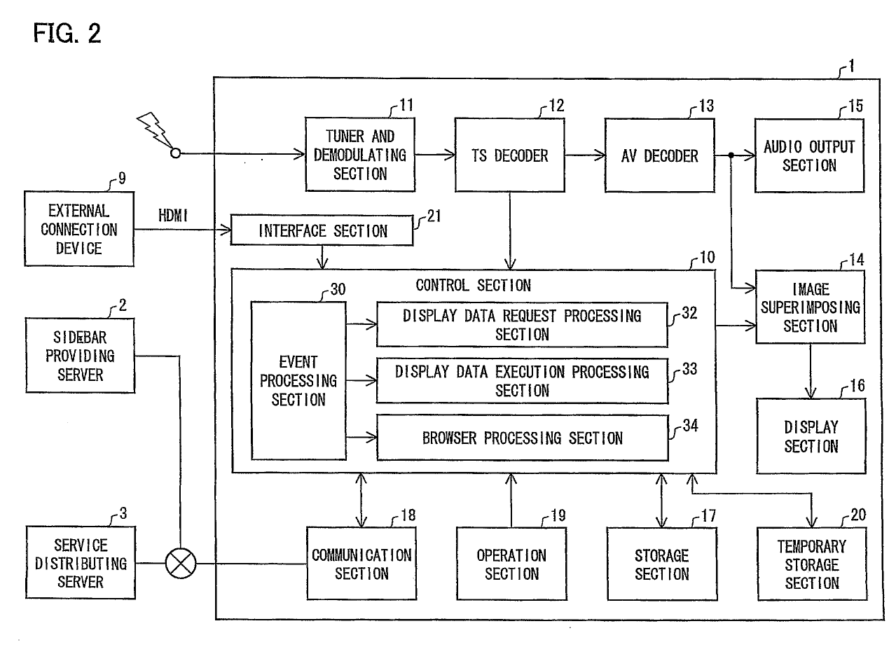

FIG. 2 is a drawing showing an example of a schematic configuration of the digital television 1 of an embodiment of the present invention. Some constituents as shown in FIG. 2 solely serve to explain general functions of a digital television and do not limit an arrangement of an information display device of the present invention.

As shown in FIG. 2, the digital television 1 includes a control section 10, a tuner and demodulating section 11, a TS (transport stream) decoder 12, an AV (audio visual) decoder 13, an image superimposing section 14, an audio output section 15, a display section 16, a communication section 18, an operation section 19, a storage section 17, a temporary storage section 20, and an interface section 21.

The control section 10 controls various kinds of operations of each section of the digital television 1. Further, the control section 10 includes, as functional blocks, an event processing section 30, a display data request processing section 32, a display data execution processing section 33 and a browser processing section 34. With this arrangement, it is possible to request the display data 7 necessary for displaying a sidebar, to display an acquired sidebar, to activate services and to display acquired services.

The tuner and demodulating section 11 for digital broadcasting carries out tuning to select a digital broadcast signal supplied via an antenna from a broadcast station (not shown), performs demodulation and error correction of the received signal in accordance with a form of the signal, and forms a multiplexed digital data. The tuner and demodulating section 11 outputs the multiplexed digital data to the TS decoder 12.

The TS decoder 12 extracts a TS (transport stream) by decoding the multiplexed digital data outputted by the tuner and demodulating section 11 and separate the TS into TS packets for different purposes. The TS packets are transmitted to the AV decoder 13 or the control section 10 in accordance with the purposes. Here, the TS is a signal sequence constituted by the TS packets of the fixed length. Each TS packet may contain data signals of program information and information necessary for channel selection, in addition to video and audio signals. The TS decoder 12 separates the extracted TS into (i) TS packets (broadcast data) that contain video and audio signals and are to be outputted to the AV decoder 13 and (ii) TS packets (information data) that contain signals of various information and are to be outputted to the control section 10.

The AV decoder 13 separates the video signal and the audio signal by decoding the TS packets (broadcast data) outputted from the TS decoder 12. The AV decoder 13 outputs the video signal to the image superimposing section 14 and the audio signal to the audio output section 15.

The image superimposing section 14 outputs, to the display section 16, screen data obtained by superimposing, on the video signal decoded by the AV decoder 13, OSD (On-Screen-Display) image data (e.g., sidebar) generated by the digital television 1. This makes it possible to display a screen on which the video signal of the broadcast data and the OSD image data such as a sidebar, a channel call, a menu panel and an electronic program guide (EPG) are superimposed.

The audio output section 15 outputs audio based on the audio signal of the digital television 1. For example, the audio output signal is realized by a speaker.

The display section 16 is a display device for displaying a video and/or an image of the digital television 1. For example, the display section 16 is realized by a display device such as an LCD (liquid crystal display), a PDP (plasma display panel) or a CRT (cathode-ray tube) display.

The storage section 17 stores a control program executed by the control section 10, an OS program and various kinds of data (e.g., service setting data later described) that is read by the control section 10 when the control section 10 carries out the display data request processing and the sidebar function. The storage section 17 is constituted by a nonvolatile storage device.

For example, a disc type storage medium such as a DVD (Digital Video Disc) and a hard disc, or a semiconductor memory such as a flash memory can be suitably used for the storage device constituting the storage section 17.

The temporary storage section 20 temporarily stores data utilized by the control section 10. The temporary storage section 20 is made of a volatile storage device. The data stored temporarily is, for example, a program read out from the storage section 17, various kinds of data, or the display data 7 acquired by the sidebar providing server 2.

The communication section 18 transmits/receives information to/from various communication devices, such as the sidebar providing server 2 and the service distributing server 3, via a communication network such as the Internet. The communication section 18 is capable of, for example, transmitting the display data request message 5 to the sidebar providing server 2 and receiving, from the sidebar providing server 2, the sidebar display data 7 customized for the digital television 1. Further, the communication section 18 is capable of communicating with the service distributing server 3 via the sidebar so as to receive, from the service distributing server 3, a target service 8.

The operation section 19 is an input device via which a user inputs a signal for operating the digital television 1. The present embodiment discusses, as an example, the operation section 19 that includes, for example, a remote controller for a remote control operation outside the digital television 1.

The digital television 1 includes, in its main body, a light receiving section (not shown) that receives an instruction signal (e.g., an infrared signal) that is inputted by a key operation on the remote controller. The instruction signal received by the light receiving section is transmitted to an input/output control section (not shown) of the control section 10. The input/output control section of the control section 10 accepts and analyzes the instruction signal that is inputted from a user into the digital television 1 via the operation section 19. Then, the instruction signal is transmitted to various sections, in need of the instruction signal, in the control section 10.

The interface section 21 performs input/output of a video signal and a control signal through, for example, an HDMI cable that is connected to an external connection device 9. The interface section 21 includes, for example, an HDMI cable terminal and an HDMI signal processing section. Examples of the external connection device 9 are a reproducing device for BD (Blue ray Disk) and an HDD (Hard Disk) recorder. The digital television 1 transmits/receives a video signal and a control signal to/from the external connection device 9 via the interface 21, so as to display a video stored in the external connection device 9 or to store, in the external connection device 9, the video signal that the digital television 1 obtains.

The event processing section 30 of the control section 10 detects various events that occur in the digital television 1, and transmits a predetermined signal to various sections of the control section 10, for example, the display data request processing section 32 and the display data execution processing section 33. For example, the event processing section 30 detects a state such that a user presses a key of the operation section 19.

The display data request processing section 32 generates the display data request message 5 for requesting a sidebar from the sidebar providing server 2.

The display data execution processing section 33 analyzes the display data 7 that is provided from the sidebar providing server 2 and displays a sidebar. The display data execution processing section 33 also accepts a selection of a service from a user and activates the service of the service distributing server 3.

The browser processing section 34 processes data such as HTML data (service 8) acquired from outside via the communication section 18 or HTML data stored in the storage section 17 in advance, and displays information contained in this data.

(Display Data Request Message)

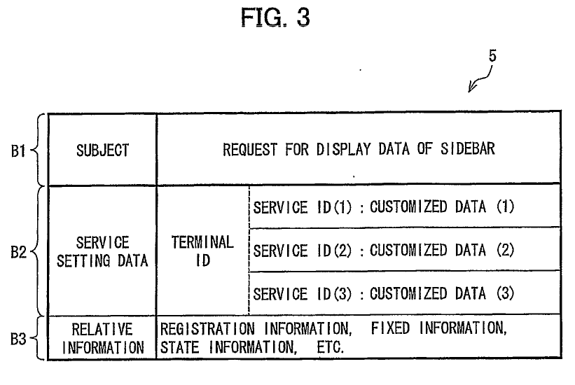

FIG. 3 is a drawing schematically illustrating a data structure of the display data request message 5 that is generated by the display data request processing section 32. In an example shown in FIG. 3, the display data request message 5 is formed as a structure including three blocks (B1 to B3) as a set. Each of the three blocks has a meaning.

A “subject” as a first block (B1) stores data indicating that the message is a message for requesting the display data 7 of the sidebar. In a case where there is no value stored in the “subject”, the sidebar providing server 2 may detect, as a default, that the message is a message for requesting the display data 7 of the sidebar.

“Service setting data” as a second block (B2) stores information (e.g., service ID (identification information of a service)) for specifying a service that a user of the digital television 1 desires to include in the sidebar. In the present embodiment, the service setting data is stored as binary data. The sidebar providing server 2 that receives the binary data takes the binary data as information that has a meaningful structure. More specifically, contents of the binary data is as follows. On the assumption that three brief descriptions of services are included in the sidebar, service IDs for the three are included in the binary data. Further, information (customization data) (setting information for acquiring information related to a service) necessary for each of the service providing servers 3 providing the services may be stored so as to correspond to a corresponding service ID. Further, in the present embodiment, a terminal ID for identifying the digital television 1 is associated with the three service IDs that are stored in the block. The terminal ID may be anything as long as the terminal ID allows the sidebar providing server 2 to uniquely identify each of digital televisions 1 to which the sidebar providing server 2 provides a sidebar. For example, a MAC address or a production serial number may be directly used as the terminal ID. Alternatively, an ID that the sidebar providing server 2 independently produces may be assigned as the terminal ID. According to the service setting data, the sidebar providing server 2 can specify a service (the service distributing server 3 from which the sidebar providing server 2 is to request an image) to be included in the sidebar that is to be provided to the digital television 1.

“Relevant information” as a third block (B3) stores information concerning the digital television 1. This information is independently stored in the digital television 1. The display data request processing section 32 stores, in this block, various kinds of relevant information stored in the storage section 17 or the temporary storage section 20.

Consequently, the sidebar providing server 2 can generate an optimum display data 7 that is customized according to the digital television 1, by using the service setting data. It is explained later in detail how the display data 7 customized according to the service setting data is generated in the sidebar providing server 2.

A data type of the data of each of the blocks is selected as appropriate according to contents, capacity, and usage that are indicated by the data.

The above explanation describes the display data request message 5 as a structure including, as a set, the three blocks. However, an arrangement of the display data request message 5 is not limited to this. For example, by connecting the above terminal ID to each corresponding block, the display data request processing section 32 may separately produce each information of the “subject”, the “service setting data”, and the “relative information” so as to transmit the information. In this case, for example, first, the “subject” that conveys a will to request the display data 7 is transmitted. Then, only the information (e.g., service setting data) necessary for the sidebar providing server 2 is generated and transmitted in response to the request from the sidebar providing server 2.

(Sidebar Providing Server)

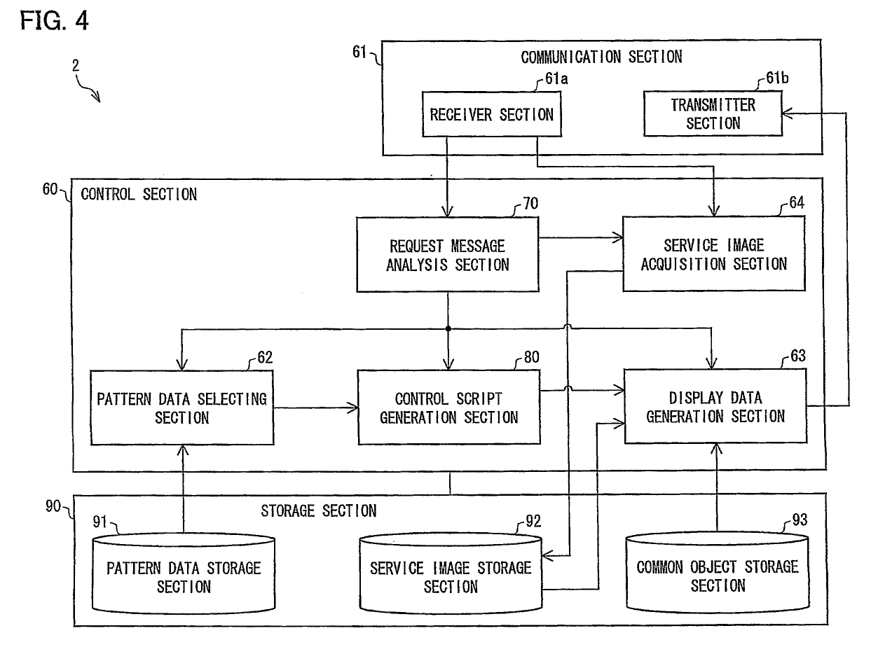

FIG. 4 is a block diagram schematically illustrating an arrangement of the sidebar providing server 2 in the embodiment of the present invention. The sidebar providing server 2, as shown in FIG. 4, includes a control section 60 that collectively controls sections of the sidebar providing server 2, a communication section 61, and a storage section 90.

The control section 60 controls various operations of the respective sections provided in the sidebar providing server 2. The control section 60 includes, as function blocks, a request message analysis section 70, a control script generation section 80, a pattern data selecting section 62, a display data generation section 63, and a service image acquisition section 64. The control section 60 reads out various programs stored in the storage section 90 and controls sections of the sidebar providing server 2 of the present invention, so as to carry out various processings for generating the display data (and a control script included in the display data).

The storage section 90 stores a control program that the control section 60 executes, an OS program, and various data that the control section 60 reads out when executing the various processings for displaying the display data. The storage section 90 is made of an involatile storage device such as a hard disk. The various data above is stored in various storage sections inside the storage section 90. In other words, the various data is stored in, for example, a pattern data storage section 90, a service image storage section 92, and a common object storage section 93. The various data stored in the storage section 90 is not limited to the data discussed above.

The communication section 61 communicates with each device of the service providing system 100 via a communication network. The communication section 61 includes a receiver section 61a and a transmitter section 61b.

Specifically, the receiver section 61a receives the display data request message 5 that is transmitted from the digital television 1. The display data request message 5 accepted via the receiver section 61a is transmitted to the request message analysis section 70 of the control section 60. Moreover, the receiver section 61a receives the image 6 that is transmitted from the service distributing server 3. The image 6 received by the receiver section 61a is transmitted to the service image acquisition section 64.

The transmitter section 61b makes a request to the service distributing server 3 for the image 6 indicative of a brief description of a service. The image 6 is necessary for producing the display data 7 requested. That is, the transmitter section 61b makes a request for the necessary image 6 to the service distributing server 3 that is designated by the service image acquisition section 64.

The transmitter section 61b transmits the display data 7 generated in response to the request from the digital television 1. That is, the transmitter section 61b transmits, to the digital television 1 that has made a request, the display data 7 transmitted from the display data generation section 63.

The request message analysis section 70 analyzes the display data request message 5 transmitted from the digital television 1. For example, the request message analysis section 70 analyzes the display data request message 5 as shown in FIG. 3, and transmits an analysis result (e.g., subject, service setting data, relative information) to sections that operates for generating the display data 7.

The service image acquisition section 64 acquires an object required for generating the requested display data 7, in accordance with the analysis result of the request message analysis section 70. More specifically, the service image acquisition section 64 (i) specifies a service distributing server 3 to be requested to provide an image 6 illustrating a brief description of a required service, based on the service ID shown in the service setting data and (ii) requests the service distributing server 3 to provide such an image 6. The storage section 90 stores information regarding the service distributing server 3 to be requested to provide the image 6, in such a manner such that the information corresponds to the service ID (service information storage section, not illustrated).

It may be arranged such that the image 6 acquired from the service distributing server 3 is stored for a predetermined period in the service image storage section 92 so that the service image acquisition section 64 acquires a desired image 6 from the service image storage section 92.

The service image acquisition section 64 may acquire an image 6 appropriate for the digital television 1 based on customization data contained in the service setting data. For example, the following explanation uses a weather forecast service as an example. It is desirable for the service image acquisition section 64 to acquire an image 6 that illustrates a brief description of a weather forecast of a region of the user that uses the digital television 1. At this time, in a case where postal code information (ZIP code) is contained in the service setting data as customization data of the weather forecast, the image 6 illustrating the brief description of the weather forecast of the region indicated by the postal code information is to be acquired from the service distributing server 3 or the service image storage section 92.

When the requested image 6 is received from the service distributing server 3, the service image acquisition section 64 stores the image 6 in the service image storage section 92.

The service image acquisition section 64 may request and acquire, not limited to the image 6, text-form data or complex data containing text-form and image-form data as information related to the brief description of the service.

The pattern data selecting section 62 selects pattern data for generating the requested display data 7 in accordance with an analysis result of the request message analysis section 70. The pattern data selecting section 62 selects, from the pattern data storage section 91, pattern data specified by the analysis result. The pattern data selected by the pattern data selecting section 62 is transmitted to the control script generation section 80 and the display data generation section 63.

The pattern data is data in which descriptions are made for a part that is common in content regardless of the digital television 1 (fixed part), in the control script which configure the display data 7 of the sidebar. Namely, the pattern data is a template of the display data 7. In the pattern data, a part other than the fixed part, that is, a part which is customized in accordance with customization data of the digital television 1, has scripts in a state such that contents can be later embedded.

The control script generation section 80 generates a control script to be contained in the requested display data 7 by use of the pattern data selected by the pattern data selecting section 62. The control script generation section 80 completes, in the entire control script, the control script of the part which require customizing by embedding the contents, by use of the analysis result of the request message analysis section 70 and the pattern data selected by the pattern data selecting section 62. For example, a script specifying an object (image 6) acquired from the service distributing server 3, or a script specifying a location (URL) of data that is to be accessed when the object is selected by a remote controller, is embedded in the part which require the customization.

In completing the control script, the control script generation section 80 determines, based on the analysis result of the request message analysis section 70 (particularly the service setting data), (i) a service to be displayed on the sidebar and (ii) an order of display of the service to be displayed on the sidebar. Further, the service to be displayed on the sidebar may be customized in accordance with the digital television which transmitted the display data request message 5, based on the customization data contained in the service setting data. Specific examples of these customizations are later described.

The control script generation section 80 that completes the control script by embedding contents from the pattern data can be realized based on known techniques disclosed in Japanese Unexamined Patent Publication, Tokukai, No. 2006-24137, for example.

The display data generation section 63 generates display data 7 specified by the display data request message 5, and transmits this display data 7 to the digital television 1. More specifically, the display data generation section 63 generates the display data 7 for displaying the sidebar requested by the digital television 1, by combining (for example, compiling to one file in zip form) (i) the control script generated by the control script generation section 80 and (ii) an object included in the control script, which object is specified by a script that specifies the object. The object may be: an image of a button commonly used in all sidebars; the image 6 acquired from the service distributing server 3; or the like. Images used in common are stored in the common object storage section 93. The image 6 acquired from the service distributing server 3 is stored in the service image storage section 92. The display data generation section 63 may select a common image suitable for the digital television 1 among a plurality of the common images, in accordance with the contents of the display data request message 5.

The display data 7 generated as such includes the request from the digital television 1, that is, an optimum control script and object in accordance with the contents (service setting data) of the display data request message 5.

According to the configuration, pattern data is selected by the pattern data selecting section 62 in accordance with the analysis result of the request message analysis section 70, and an optimum content is specified by the control script generation section 80. In addition, the image 6 that forms the sidebar is acquired by the service image acquisition section 64. Thus, the sidebar providing server 2 is capable of completing an appropriate display data in accordance with the service setting data of the digital television 1, and provide this display data 7 to the digital television 1. Subsequently, the digital television 1 can carry out the sidebar function based on the display data that is appropriately customized.

From the above, it is possible to customize the display data 7 in accordance with the contents of the service setting data of the digital television 1 requesting for the display data 7.

(Display Data)

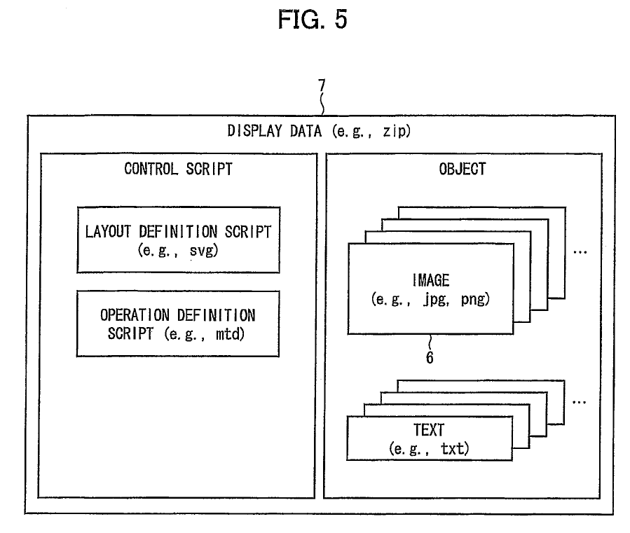

FIG. 5 is a drawing schematically showing a data structure of the display data 7 generated by the display data generation section 63. The display data 7 is information required by the digital television 1 for generating the sidebar. As shown in FIG. 5, the display data 7 in the embodiment of the present invention contains a control script and an object.

The control script specifies an operation taken when the digital television 1 carries out the sidebar function. Namely, a control order with respect to the digital television 1 is included in the control script. The object is data that is to be displayed on the digital television 1, and is specifically, image data in jpg or png format, text data, and the like. As described above, the object includes the image 6 acquired from the service distributing server 3 and the like. Further, in a case where information regarding a brief description of the service is displayed in a text form, text-form data may also be included. Contents of the text data may be (a) customized data generated by the display data generation section 63 in accordance with the contents of the display data request message 5, (b) data included in the pattern data selected by the pattern data selecting section 62, or (c) fixed data.

The data format of the object is not limited to the example shown in FIG. 5, and may be of any data format as long as the digital television 1 can handle the data so as to display the data on the digital television 1.

In the present embodiment, the control script is largely classified into two types.

A first type is a layout definition script, which specifies how and on which position the object is to be displayed. The layout definition script includes how the object to be displayed corresponds to layout information such as a display position and display size of the object. Due to this layout definition script, the digital television 1 knows how and where to display which object in the display data 7.

A second type is an operation definition script, which specifies contents of predetermined operations to be carried out by the digital television 1 in accordance with an event that occurs (e.g. elapse of a predetermined time, start/end of a predetermined operation, receiving display data, or remote control entering by a user) in the digital television 1. The operation definition script defines the operations of the digital television 1 in detail, for example, which of the display data 7 is to be displayed (requested and acquired) subsequently to what kind of event that has occurred. The operation definition script enables the digital television 1 to determine how to process which data at what timing to which device.

The control script may be arranged as, for example, text-form data described by XML (eXtensible Markup Language). Content of the control script can be easily modified and provided to the digital television 1. The layout definition script may be described as, for example, SVG (Scalable Vector Graphics).

As described above, modification of a description in the control script contained in the display data 7 in the sidebar providing server 2 allows easy modification of a specification of the sidebar function to be carried out by the digital television 1, without carrying out any modification to basic functions incorporated in a ROM of the digital television 1.

(Data Format of Service Setting Data)

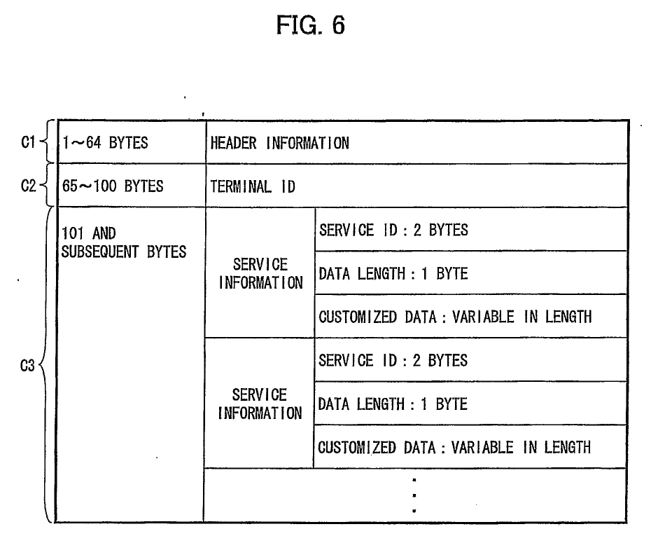

The following description explains a data format of the service setting data, with reference to FIG. 6. FIG. 6 is a schematic drawing showing a data format of the service setting data.

In the present embodiment, service setting data is handled as binary data (fixed length of 1024 bytes). The service setting data includes three blocks (C1 to C3), each of which has a meaning. That is to say, the service setting data includes “header information” as a first block (C1), “terminal ID” as a second block (C2), and “service information” as a third block (C3).

The “header information” is stored from a head of the service setting data, i.e., 1^{st} byte to 64^{th} byte. The “header information” is information for specifying that the data is the service setting data. Additionally, information to be managed by the digital television may also be stored. Note that, even if the service setting data is rewritten to default data, the “header information” will not be rewritten.

The “terminal ID” for identifying the digital television 1 is stored in 65^{th} byte to 100^{th} byte of the service setting data. The “terminal ID” is information described in a format following a legitimate term as follows:

[0-9a-f]{8}-[0-9a-f]{4}-[0-9a-f]{4}-[0-9a-f]{4}-[0-9a-f]{12}

The “service information” is stored in the 101^{st} and subsequent bytes. The “service information” is information that repetitively includes a set of “service ID” (identification information of a service), “data length” and “customized data” (setting information), for each service.

The “service ID” has a length of 2 bytes, and stores identification information of a service. In the “service ID”, a service ID of a service to be displayed in the sidebar is stored.

The service ID of a minus value is used as an ID reserved for special services. Moreover, the service ID having a value of 0 is used for indicating an end of data.

The “data length” has a length of 1 byte, and stores a value indicating a byte length of following “customization data”.

The “customization data” is changeable in length, and is stored with information (for example ZIP code and the like) required in providing each of the services.

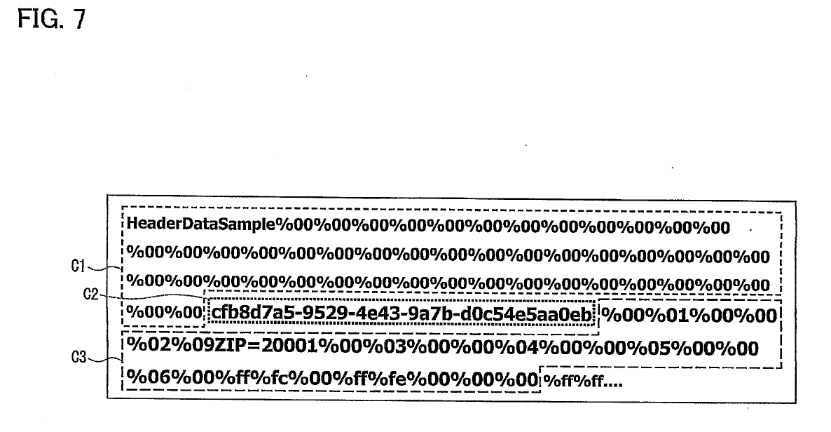

Next is an explanation of an example of data of the service setting data, with reference to FIG. 7. FIG. 7 is a schematic drawing showing an example of data of the service setting data. In this example, the header information includes a text of “HeaderDataSample”. Moreover, a terminal ID of “cfb8d7a5-9529-4e43-9a7b-d0c54e5aa0eb” is included in the terminal ID. In the service information, “1”, “2”, “3”, “4”, “5”, “6”, “−2” and “−4” are included as the service IDs. In addition, a value of “ZIP=20001” is included as the customization data for the service which has the service ID of “2”.

(Generation Procedures of Display Data Customized in Accordance with Service Setting Data)

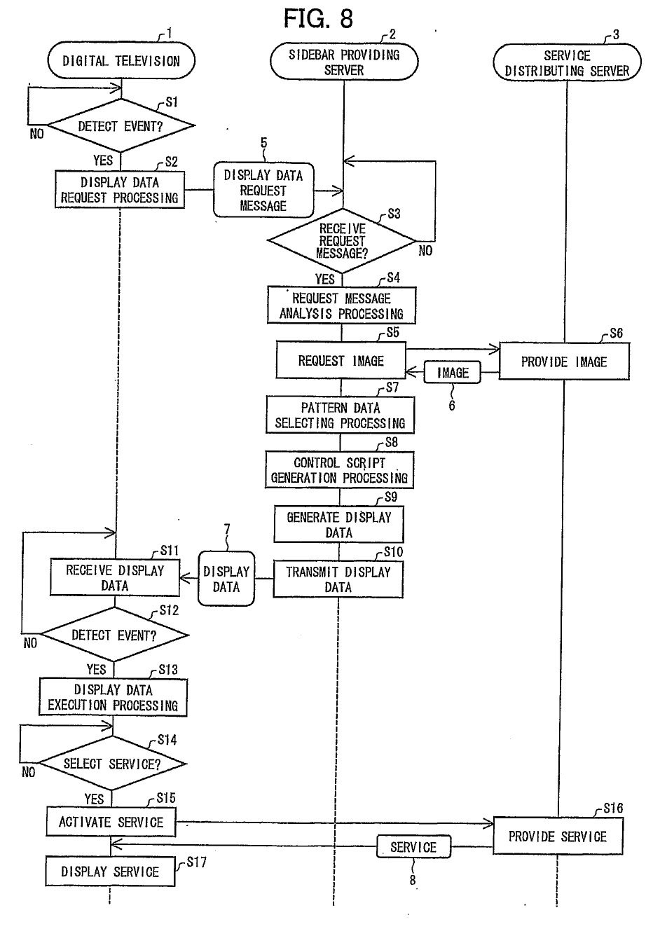

The following description explains, with reference to FIG. 8, an example of a series of processing steps in which the sidebar providing server 2 (i) generates display data 7 customized in accordance with service setting data and (ii) transmits the display data 7 thus generated to the digital television 1.

When the event processing section 30 of the digital television 1 detects an input of an instruction entered from the operation section 19 for displaying a sidebar (YES in a step 51), the display data request processing section 32 generates a display data request message 5 and transmits this display data request message 5 to the sidebar providing server 2 (a step S2).

When the sidebar providing server 2 receives the display data request message 5 from the digital television 1 (YES in a step S3), the request message analysis section 70 analyzes this received display data request message 5 (a step S4). As described above, a result of analysis contains service setting data.

The service image acquisition section 64, in accordance with the result of analysis of the step S4, specifies a service that is requested, and requests the service distributing server 3 that provides the service thus specified to provide an image 6 that shows a brief description of the service (a step S5). As described above, it is alternatively possible to acquire an image 6 that has been stored in the service image storage section 92 for a predetermined period. Moreover, as explained above in the example of the weather forecast service, the service image acquisition section 64 may acquire, based on the customization data (e.g., postal code information) included in the service setting data, an image 6 in accordance with the digital television 1 (such as an image showing a brief description of a weather forecast of a region indicated by the postal code information).

In response to the request of the step S5, the service distributing server 3 provides the image 6 (a step S6).

On the other hand, in accordance with the result of analysis of the step S4, the pattern data selecting section 62 selects pattern data for generating the display data 7 which is to be provided to the digital television 1 (a step S7).

Subsequently, the control script generation section 80 generates a control script to cause the digital television 1 carry out a sidebar function customized to suit the digital television 1, based on a selected pattern data and an acquired image 6 (a step S8).

Meanwhile, the control script generation section 80 determines, based on a service ID contained in the service setting data (result of analysis), (i) a service to be displayed on the sidebar and (ii) a display order of the service to be displayed on the sidebar. A method for determining which service is to be displayed on the sidebar is not particularly limited. For example, the service to be displayed may be determined by the following method: (A) determining to display every service that correspond to the service ID thus extracted; or (B) determining the service to be displayed based on information related to the service (for example, whether or not the service is in a campaign period, whether or not the service is charged, or the like). Examples of (B) include determining of not displaying services that is not in the campaign period, and determining of not displaying services that are charged.

The method for determining the order of display of the service determined to be displayed is not particularly limited. For example, the order of displaying the service may be determined in the following method: (C) determining the order of display in accordance with the order of the service ID contained in the service setting data; or (D) determining the order of display in accordance with information related to the service (for example, information such as a preset priority level of the service, or whether or not the service is charged). An example of the method (D) is, to display services that are in a campaign period earlier than other services.

Following this, the display data generation section 63 generates the display data 7 which contains (i) the control script generated by the control script generation section 80 and (ii) an object (a step S9).

Finally, the transmission section 61b transmits the display data 7 generated in the step S9 to the digital television 1 which requested for the display data 7 (a step S10).

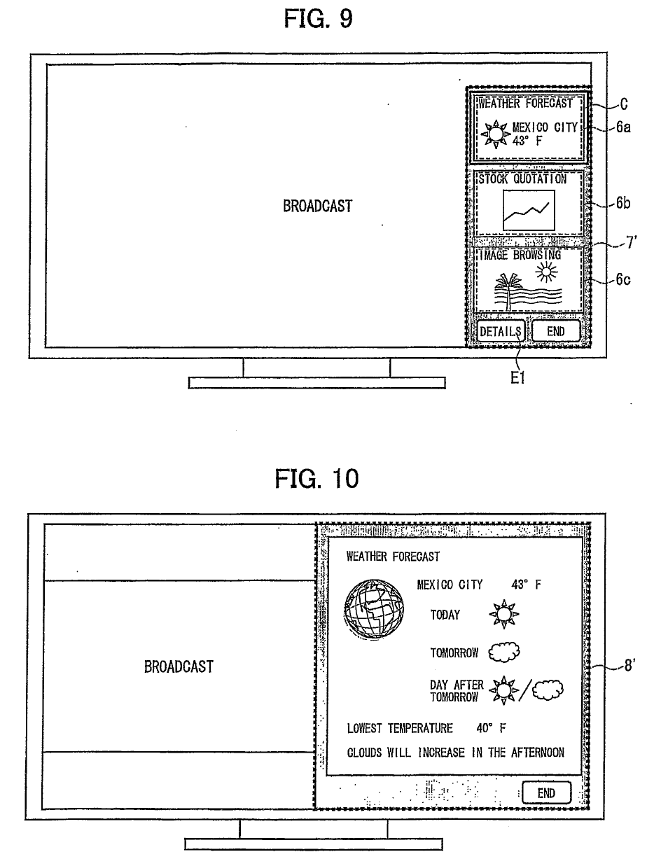

The digital television 1 receives the display data 7 from the sidebar providing server 2 (a step S11). When the event processing section 30 of the digital television 1 detects a predetermined event (reception of requested display data 7) (YES in a step S12), the display data execution processing section 33 executes a processing step of the display data 7 thus received (a step S13). Namely, the display data execution processing section 33 displays a sidebar 7′ in accordance with the control script contained in the display data 7 (FIG. 9). The sidebar 7′ shown in FIG. 9 displays an image 6a showing a brief description of a weather forecast, an image 6b showing a brief description of stock quotation service, and an image 6c showing a brief description of an image browsing service.

Subsequently, when the event processing section 30 detects, in the sidebar 7′ shown in FIG. 9, that a button of a remote controller as displayed on a screen as shown as E1 is selected in a state in which a cursor C is at the image 6a (image showing the brief description of the weather forecast service) (YES in a step S14), the display data execution processing section 33, in accordance with the control script, accesses the browser processing section 34 and instructs the browser processing section 34 to activate the service (the weather forecast service in this case). The browser processing section 34 requests the service distributing server 3 to provide a service 8 (a step S15).

The browser processing section 34 downloads the service 8 (for example, HTML data or the like) from the service distributing server 3 (a step S16), and displays the service 8 on the display section 16 of the digital television 1 (a step S17) (FIG. 10). In FIG. 10, the weather forecast service is displayed on the digital television 1.

According to the method, the sidebar providing server 2 can generate the display data 7 for displaying a sidebar by customizing the data for each digital television 1, in accordance with the service setting data contained in the display data request message 5 transmitted from the digital television 1. The digital television 1 can carry out the sidebar function that is customized to suit the digital television 1 based on the control script included in the display data 7. The sidebar displays, for example, a brief description of a service desired by the user, and embeds a URL for accessing the service. Therefore, by use of the customized sidebar, the user can easily acquire a desired service. Further to this, as a parameter, the service setting data of the service may be added to the URL for accessing the service. This allows application of the customization to the URL, which enables browsing of the service accessed by the browser to be in a customized state for an individual. For example, with the weather forecast service, addition of a ZIP code to the URL allows browsing, with a browser, of (i) an image of the weather forecast that is customized based on the ZIP code and is OSD displayed, and (ii) detail information of the weather forecast based on the same ZIP code.

Although not shown in FIG. 8, in a case where (i) the service setting data transmitted from the digital television 1 to the sidebar providing server 2 is broken or (ii) the digital television 1 does not have the service setting data, the sidebar providing server 2 may transmit a default service setting data that is prepared in the sidebar providing server 2 in advance, and store this default service setting data in the digital television 1. Accordingly, when a display of the sidebar is requested a next time, a display data request message 5 which contains the default service setting data may be transmitted to the sidebar providing server 2. Further, in a case where an unusable service is included in the service setting data transmitted by the digital television 1, which service is unusable due to reasons such as termination of service, the sidebar providing server 2 may (i) remove, from the service setting data, just specific service information that has the problem, (ii) restructure the service setting data and (iii) transmit such restructured service setting data to the digital television 1.

(Screen Example)

The following description explains an example of a screen on which the sidebar is displayed, with reference to FIGS. 9, 11, and 12.

As described above, FIG. 9 shows a state in which a sidebar 7′ is displayed on the display section 16 of the digital television 1. The sidebar 7′ shown in FIG. 9 displays an image 6a showing a brief description of a weather forecast service, an image 6b showing a brief description of a stock quotation service, and an image 6c showing a brief description of an image browsing service.

That is to say, FIG. 9 shows that: the display data request message 5 which contains the service setting data including each of the service IDs that correspond to the weather forecast service, stock quotation service, and image browsing service, respectively, is transmitted from the digital television 1; in response to this, the sidebar providing server 2, based on the service setting data, (i) determines to display the image 6a showing the brief description of the weather forecast service, the image 6b showing the brief description of the stock quotation service, and the image 6c showing the brief description of the image browsing service in this order, and (ii) generates the display data 7 based on such determination.

In FIG. 9, a weather forecast of Mexico City region is displayed as the image showing the brief description of the weather forecast service. This is because the postal code information (ZIP code) indicative of the Mexico City region is set in the service setting data as the customization data that corresponds to the service ID of the weather forecast service. Based on the postal code information, the sidebar providing server 2 generates the display data 7 which contains the image 6a showing the brief description of the weather forecast of the Mexico City.

The following description explains another example in which a sidebar 7′ is displayed on the display section 16 in the digital television 1, with reference to FIG. 11. The sidebar 7′ shown in FIG. 11 displays the image 6a showing the brief description of the weather forecast service, the image 6c showing the brief description of the image browsing service, and an image 6d showing a brief description of a sports information service.

That is to say, FIG. 11 shows that: the display data request message 5 which contains the service setting data including each of the service IDs that correspond to the weather forecast service, image browsing service, and sports information service, respectively, is transmitted from the digital television 1; in response to this, the sidebar providing server 2 (i) determines, based on the service setting data, to display the weather forecast service, the image browsing service, and the sports information service in this order, and (ii) generates the display data 7 based on such determination.

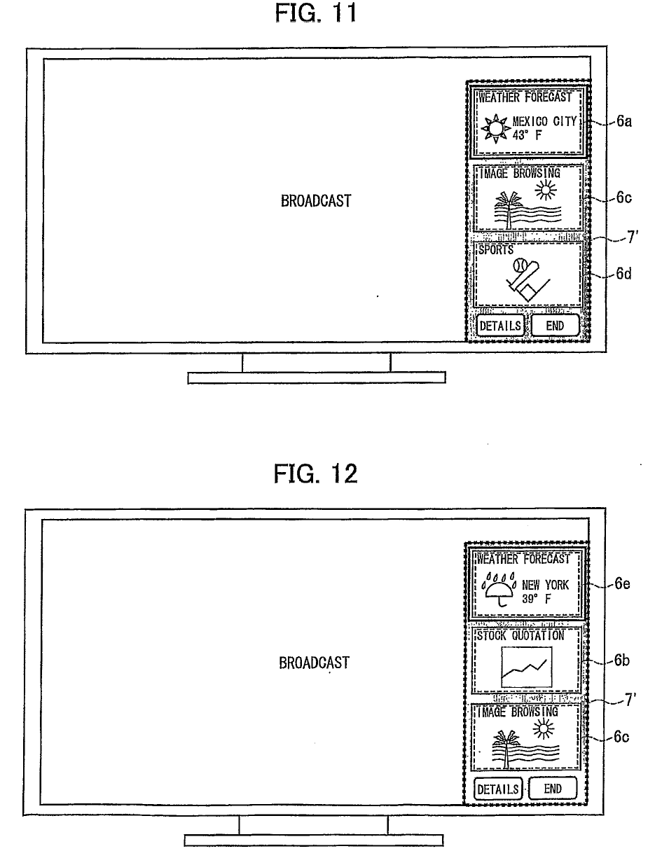

Next is a description explaining another example in which a sidebar 7′ is displayed on the display section 16 in the digital television 1, with reference to FIG. 12. The sidebar 7′ shown in FIG. 2 displays an image 6e showing a brief description of a weather forecast service, the image 6b showing the brief description of the stock quotation service, and the image 6c showing the brief description of the image browsing service.

That is to say, FIG. 12 shows that: the display data request message 5 which contains the service setting data including each of the service IDs that correspond to the weather forecast service, stock quotation service, and image browsing service, respectively, is transmitted from the digital television 1; in response to this, the sidebar providing server 2, (i) determines, based on the service setting data, to display the weather forecast service, the stock quotation service, and the image browsing service in this order, and (ii) generates the display data 7 based on such determination.

In FIG. 12, a weather forecast of New York City region is displayed as the image showing the brief description of the weather forecast service. This is because the postal code information (ZIP code) indicative of the New York City region is set as the customization data that corresponds to the service ID of the weather forecast service, in the service setting data. Based on the postal code information, the sidebar providing server 2 generates the display data 7 which contains the image 6e showing the brief description of the weather forecast of the New York City.

(Effect)

As described above, the digital television 1 manages service setting data in its storage section 17. Accordingly, when the sidebar is to be displayed, the digital television 1 transmits a display data request message 5 to the sidebar providing server 2. Note that the display data request message 5 contains the service setting data thus managed. The sidebar providing server 2, in response, generates display data 7 based on the service setting data contained in the display data request message 5. The sidebar providing server 2 then transmits, to the digital television 1, the display data 7 thus generated; the digital television 1 displays a sidebar generated based on the display data 7 thus received.

That is to say, although the digital television 1 manages the service setting data to be transmitted to the sidebar providing server 2 in the digital television 1, the digital television 1 does not generate the display data 7 to be displayed in the sidebar by use of the service setting data thus managed. Instead, the sidebar providing server 2 generates the display data 7 by use of the service setting data transmitted from the digital television 1.

Therefore, the sidebar providing server 2 can control (i) which service to include in the sidebar to be displayed on the digital television 1 and (ii) in which order the service is to be displayed.

As a result, for example, in a case where the sidebar providing server 2 knows that there is a service which has stopped offering its service from the service distributing server 3, display control can be carried out just by the sidebar providing server 2, such as not including in the sidebar the service thus stopped.

Moreover, for example, if the sidebar providing server 2 knows that there is a service that is in a campaign period, display control may be carried out just by the sidebar providing server 2, for example, such that the service that is in the campaign period is displayed earlier than other services.

Further, the sidebar providing server 2 can carry out customization in accordance with the digital television 1, by acquiring an image 6 in accordance with the digital television 1 based on customization data (e.g., postal code information) included in the service setting data.

As described above, transmission of the service setting data to the sidebar providing server 2 by the digital television 1 allows flexible control in (i) which service to include in the sidebar, (ii) what order the service is to be displayed, and (iii) what type of image showing the brief description of the service is to be displayed in the sidebar, just by the sidebar providing server 2. Therefore, there is no need to make any modifications in a function provided in the digital television 1, along with the modification in the service to be displayed in the sidebar. As a result, an effect is attained such that maintenance of a service providing system 100 is easily carried out.

The sidebar providing server 2 generates the display data 7 by use of the service setting data. As a result, there is no need for the digital television 1 to have a function for generating the display data 7 by use of the service setting data. Furthermore, the digital television 1 is sufficient as long as the digital television 1 is capable of reading out from and writing in to the storage section 17, the service setting data.

There is no need for the digital television 1 to perceive what kind of data format the service setting data is.

Therefore, for example, even in a case where a specification such as a data format of the service setting data is modified due to a specification modification of the display data 7, there is no need to make any modifications to the function provided in the digital television 1. This attains an effect such that it is possible to handle specification modification by just modifying the function provided in the sidebar providing server 2.

(Additional Matters)

Finally, the control sections 10 and 60 may be realized by way of hardware or software as executed by a CPU. In a case where the control sections 10 and 60 are realized by way of software, the digital television 1 and the sidebar providing server 2 each include a CPU (central processing unit) and memory devices (memory media). The CPU (central processing unit) executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the digital television 1 and the sidebar providing server 2 a computer-readable storage medium containing control program code (executable program, intermediate code program, or source program) for the digital television 1 and the sidebar providing server 2, which is software realizing the aforementioned functions, in order for the computer (or CPU, MPU) to retrieve and execute the program code contained in the storage medium.

The storage medium may be, for example, a tape, such as a magnetic tape or a cassette tape; a disk including a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The digital television 1 and the sidebar providing server 2 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL line; or wireless, such as infrared radiation (IrDA, remote control), Bluetooth®, 802.11 wireless, HDR, mobile telephone network, satellite line, or terrestrial digital network. The present invention encompasses a carrier wave or data signal transmission in which the program code is embodied electronically.

The present invention is not limited to the description of the embodiments above, but may be altered by a skilled person within the scope of the claims. An embodiment based on a proper combination of technical means disclosed in different embodiments is encompassed in the technical scope of the present invention.

### Effect of the Invention

As described above, an information providing device according to the present invention is an information providing device which provides display data for presentation of a user interface on an information display device, the information display device acquiring information related to one or more services from a service providing device via the user interface and displaying the information thus acquired, the information providing device, including: a service setting data receiving section for receiving, from the information display device, service setting data which includes (i) setting information for causing the information display device to acquire the information related to the one or more services and (ii) identification information of the one or more services; a control script generation section for generating a control script which causes the information display device to display an object indicating a brief description of the one or more services, the object being associated with the setting information included in the service setting data thus received; and a display data transmission section for generating display data which includes the object and the control script thus generated, and transmitting the display data thus generated to the information display device.

Moreover, an information providing method according to the present invention is a method for controlling an information providing device which provides display data for presentation of a user interface on an information display device, the information display device acquiring information related to one or more services from a service providing device via the user interface and displaying the information thus acquired, the method including the steps of: receiving, from the information display device, service setting data which includes (i) setting information for causing the information display device to acquire the information related to the one or more services and (ii) identification information of the one or more services; generating a control script which causes the information display device to display an object indicating a brief description of the one or more services, the object being associated with the setting information included in the service setting data thus received; generating display data which includes the object and the control script thus generated; and transmitting the display data thus generated to the information display device.

Thus, it is possible to (i) generate the display data which includes the object corresponding to the setting information included in the service setting data, which service setting data is received from the information display device, and (ii) transmit this display data thus generated to the information display device.

Therefore, an effect is attained such that control for including, to the display data, the object that corresponds to the setting information is carried out just by the information providing device, that is, the server device. In other words, an effect is attained such that control for displaying the object on the information display device is carried out just by the information providing device.

Further, the information providing device according to the present invention may be arranged such that the information display device stores the service setting data as fixed length data in a first storage section of the information display device, and the service setting data receiving section receives the service setting data stored in the first storage section in units of the fixed length data.

According to the arrangement, the service setting data that is stored as the fixed length data in the first storage section can be received as it is.

Hence, the service setting data that is to be received is data which has not been subjected to modification or update by the information display device.

This allows carrying out control for displaying the object on the information display device just by the information providing server, that is, the server device.

Further, the information providing device according to the present invention may be arranged such that in a case where attribute information of the one or more services is included in a group of attribute information of a service in which the object is displayed on the information display device, the service being identified by the identification information included in the service setting data received by the service setting data receiving section, and the group of attribute information being set, in advance, in a second storage section of the information providing device, the control script generation section generates the control script for causing the information display device to display the object of the service which (i) is identified by the identification information included in the service setting data thus received, and (ii) has the attribute information which is included in the group.

With the arrangement, in a case where attribute information of the one or more services that is identified by the identification information included in the service setting data thus received is included in the group of attribute information set in advance, it is possible to generate a control script for causing the information display device to display the object of the service that has the attribute information.

This allows generation of the control script that causes display of the object in accordance with the attribute information of the service.

Therefore, an effect is attained such that whether or not to display the object on the information display device can be controlled by the information providing device, in accordance with the attribute information of the service.

Further, the information providing device according to the present invention may be arranged such that in a case where the attribute information of the one or more services is included in a group of attribute information of a service in which the object is displayed in priority to other objects on the information display device, the service being identified by the identification information included in the service setting data received by the service setting data receiving section, and the group of attribute information being set, in advance, in the second storage section of the information providing device, the control script generation section generates the control script for displaying the object of the service in priority to the other objects, the service (i) being identified by the identification information included in the service setting data thus received, and (ii) having the attribute information which is included in the group.

With the arrangement, in a case where attribute information of the one or more services that is identified by the identification information included in the service setting data thus received is included in the group of attribute information set in advance, it is possible to generate the control script for causing the information display device to display, in priority to other objects, the object of the service that has the attribute information.

This allows generation of the control script which causes display of the object in priority to other objects, in accordance with the attribute information of the service.

Therefore, an effect is attained such that the information providing device can control whether or not to display the object in priority to the other objects on the information display device, in accordance with the attribute information of the service.

Further, the information providing device according to the present invention may be arranged such that the service setting data is data of a binary format and includes an area in which combinations of the identification information of the service and the setting information are stored.

According to the arrangement, the service setting data at least includes an area which stores combinations of the identification information of the service and the setting information. Moreover, the data is of a binary format.

Thus, it is possible to acquire the identification information of the service and the setting information by referring to the area in the data of the binary format. Namely, it is possible to carry out a generation processing of the control script by use of the identification information of the service and the setting information, each of which are acquired by referring to the area of the received service setting data of the binary format.

Therefore, an effect is attained such that controlling of including the object in the display data, which object corresponds to the setting information, can be carried out just by the information providing device, that is, the server device, by use of the identification information of the service and the setting information, each of which is acquired from the service setting data in the binary format that includes the area.

Further, the information providing device according to the present invention may further include an object acquisition section for acquiring the object from the service providing device.

According to the arrangement, the object can be acquired from the service providing device.

This enables acquisition of the object that is provided by the service providing device at that point of time.

Therefore, an effect is attained such that an object according to a providing situation is acquirable, in a case where, for example, the service providing device provides the object in accordance with a providing situation of the service.

An information display device according to the present invention includes: a display data requesting section for transmitting service setting data stored in a first storage section in units of fixed length data to the information providing device so as to carry out a request for providing display data with respect to the information providing device to provide display data; and a display data displaying section for causing a display section of the information display device to display the object included in the display data acquired from the information providing device in response to the request, based on the control script included in the display data acquired from the information providing device.

According to the arrangement, the service setting data that is stored as the fixed length in the first storage section can be transmitted to the information providing device as it is.

Hence, there is no need for the information display device to know what format the service setting data is in, or what kind of data is stored in the service setting data.

Therefore, an effect is attained such that control of displaying the object on the information display device can be carried out just by the information providing device, that is, the server device, even if the information display device does not perceive what data format the service setting data is in, or what kind of data is stored in the service setting data.

An information providing system according to the present invention includes: the information providing device; and the information display device.

According to the present invention, the information display device collectively reads out the service setting data stored in the second storage section and transmits this service setting data as it is to the information providing device. Subsequently, the information providing device receives the service setting data from the information display device. The information providing device generates the control script for causing the information display device to display the object that corresponds to the setting information included in the service setting data thus received. The information providing device further generates the display data including the object and the control script thus generated, and transmits a generated display data to the information display device. Accordingly, the information display device displays the object on its display section in accordance with the control script included in the display data acquired from the information providing device.

This allows the information providing device to transmit display data generated based on the service setting data collectively read out from the second storage section by the information display device, and the information display device to display the object on its device based on the display data.

As a result, control for displaying the object on the information display device can be carried out just by the information providing device which is the server device, even if the information display device does not perceive what data format the service setting data is in, or what kind of data is stored in the service setting data.

### INDUSTRIAL APPLICABILITY

The present invention is applicable to information display devices which display various information, and information providing devices which provide data for display on the information display devices. Particularly, the present invention is suitably used for information providing devices which provide brief description information related to one or more than one service to information display devices, which brief description information is provided from service providing devices.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

1. An information providing device which provides display data for presentation of a user interface on an information display device, the information display device acquiring information related to one or more services from a service providing device via the user interface and displaying the information thus acquired,
said information providing device, comprising:
service setting data receiving means for receiving, from the information display device, service setting data which includes (i) setting information for causing the information display device to acquire the information related to the one or more services and (ii) identification information of the one or more services;
control script generation means for generating a control script which causes the information display device to display an object indicating a brief description of the one or more services, the object being associated with the setting information included in the service setting data thus received; and
display data transmission means for generating display data which includes the object and the control script thus generated, and transmitting the display data thus generated to the information display device.

2. The information providing device as set forth in claim 1, wherein
the information display device stores the service setting data as fixed length data in a first storage section of the information display device, and
the service setting data receiving means receives the service setting data stored in the first storage section in units of the fixed length data.

3. The information providing device as set forth in claim 1, wherein
in a case where attribute information of the one or more services is included in a group of attribute information of a service in which the object is displayed on the information display device, the service being identified by the identification information included in the service setting data received by the service setting data receiving means, and the group of attribute information being set, in advance, in a second storage section of the information providing device,
the control script generation means generates the control script for causing the information display device to display the object of the service which (i) is identified by the identification information included in the service setting data thus received, and (ii) has the attribute information which is included in the group.

4. The information providing device as set forth in claim 1, wherein
in a case where the attribute information of the service is included in a group of attribute information of services of which its object is to be displayed in priority to other objects on the information display device, the service being identified by the identification information included in the service setting data received by the service setting data receiving means, and the group of attribute information being set in a second storage section of the information providing device in advance,
the control script generation means generates the control script for causing the information display device to display the object of the service in priority to the other objects, the service (i) being identified by the identification information included in the service setting data thus received, and (ii) having the attribute information which is included in the group.

5. The information providing device as set forth in claim 1, wherein the service setting data is data of a binary format and includes an area in which combinations of the identification information of the service and the setting information are stored.

6. The information providing device as set forth in claim 1, further comprising object acquisition means for acquiring the object from the service providing device.

7. An information display device comprising:
display data requesting means for transmitting service setting data stored in a first storage section in units of fixed length data to an information providing device recited in claim 1 so as to carry out a request for providing display data with respect to the information providing device to provide display data; and
display data displaying means for causing a display section of the information display device to display the object included in the display data acquired from the information providing device in response to the request, based on the control script included in the display data acquired from the information providing device.

8. An information providing system comprising:
an information providing device which provides display data for presentation of a user interface on an information display device, the information display device acquiring information related to one or more services from a service providing device via the user interface and displaying the information thus acquired; and
said information display device,
said information providing device, including:
service setting data receiving means for receiving, from the information display device, service setting data which includes (i) setting information for causing the information display device to acquire the information related to the one or more services and (ii) identification information of the one or more services;
control script generation means for generating a control script which causes the information display device to display an object indicating a brief description of the one or more services, the object being associated with the setting information included in the service setting data thus received; and
display data transmission means for generating display data which includes the object and the control script thus generated, and transmitting the display data thus generated to the information display device, and
said information display device including:
display data requesting means for transmitting the service setting data stored in a first storage section in units of fixed length data to the information providing device so as to carry out a request for providing display data with respect to the information providing device to provide display data; and
display data displaying means for causing a display section of the information display device to display the object included in the display data acquired from the information providing device in response to the request, based on the control script included in the display data acquired from the information providing device.

9. An information providing method for controlling an information providing device which provides display data for presentation of a user interface on an information display device, the information display device acquiring information related to one or more services from a service providing device via the user interface and displaying the information thus acquired,
said method comprising the steps of:
receiving, from the information display device, service setting data which includes (i) setting information for causing the information display device to acquire the information related to the one or more services and (ii) identification information of the one or more services;
generating a control script which causes the information display device to display an object indicating a brief description of the one or more services, the object being associated with the setting information included in the service setting data thus received;
generating display data which includes the object and the control script thus generated; and
transmitting the display data thus generated to the information display device.

10. A program for causing a computer to function as each of means of the information providing device, the information providing device providing display data for presentation of a user interface on an information display device, the information display device acquiring information related to one or more services from a service providing device via the user interface and displaying the information thus acquired,
said information providing device, comprising:
service setting data receiving means for receiving, from the information display device, service setting data which includes (i) setting information for causing the information display device to acquire the information related to the one or more services and (ii) identification information of the one or more services;
control script generation means for generating a control script which causes the information display device to display an object indicating a brief description of the one or more services, the object being associated with the setting information included in the service setting data thus received; and
display data transmission means for generating display data which includes the object and the control script thus generated, and transmitting the display data thus generated to the information display device.

11. A program for causing a computer provided in an information display device to function as each of means of the information display device, the information display device acquiring information related to one or more services from a service providing device via the user interface and displaying the information thus acquired,
said information display device, comprising:
display data requesting means for transmitting service setting data stored in a first storage section in units of fixed length data to an information providing device so as to carry out a request for providing display data with respect to the information providing device to provide display data, the information providing device providing display data for presentation of a user interface on the information display device; and
display data displaying means for causing a display section of the information display device to display the object included in the display data acquired from the information providing device in response to the request, based on the control script included in the display data acquired from the information providing device.

12. A computer-readable storage medium in which a program for causing a computer provided in an information providing device to function as each of means of the information providing device is stored, the information providing device providing display data for presentation of a user interface on an information display device, the information display device acquiring information related to one or more services from a service providing device via the user interface and displaying the information thus acquired,
said information providing device, comprising:
service setting data receiving means for receiving, from the information display device, service setting data which includes (i) setting information for causing the information display device to acquire the information related to the one or more services and (ii) identification information of the one or more services;
control script generation means for generating a control script which causes the information display device to display an object indicating a brief description of the one or more services, the object being associated with the setting information included in the service setting data thus received; and
display data transmission means for generating display data which includes the object and the control script thus generated, and transmitting the display data thus generated to the information display device.

13. A computer-readable storage medium in which a program for causing a computer provided in an information display device to function as each of means of the information display device is stored, the information display device acquiring information related to one or more services from a service providing device via the user interface and displaying the information thus acquired,
said information display device, comprising:
display data requesting means for transmitting service setting data stored in a first storage section in units of fixed length data to an information providing device so as to carry out a request for providing display data with respect to the information providing device to provide display data, the information providing device providing display data for presentation of a user interface on the information display device; and
display data displaying means for causing a display section of the information display device to display the object included in the display data acquired from the information providing device in response to the request, based on the control script included in the display data acquired from the information providing device.
